(19) United States
(12) Patent Application Publication
(10) Pub. No.: US 2007/0118482 A1
(43) Pub. Date: May 24, 2007

(54) Security display

(75) Inventors: Pim Theo Tuyls, Eindhoven (NL); Adrianus Sempel, Eindhoven (NL); Geert Jan Schrijen, Eindhoven (NL); Pieter Jacob Snijder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,459

(22) PCT Filed: Dec. 13, 2004
(86) PCT No.: PCT/IB04/52781

§ 371 Date: Jun. 14, 2006

(30) Foreign Application Priority Data
Dec. 19, 2003 (EP) 03104836.6

(51) Int. Cl. G06Q 99/00

(52) U.S. Cl. 705/62

(57) ABSTRACT

A device (1) for decrypting encrypted images comprises an array of sensor elements (11) for sensing a first image, for example an encrypted image, and an array of display elements (12) for displaying a second image, for example a decrypted image. At least some display elements comprise integrated sensor elements, thus reducing the number of parts of the device. The integrated display/sensor elements (13) may be constituted by polymeric LED elements. The sensor function of the integrated elements may also be used for positioning the device relative to a terminal, and/or for checking a biometric feature of the user.

The present invention relates to a security display. More in particular, the present invention relates to a device for decrypting encrypted images, the device comprising an array of sensor elements for sensing a first image, such as an encrypted image, and an array of display elements for displaying a second image, such as a decrypted image.

A security display device for decrypting encrypted images is disclosed in, for example, International Patent Application WO 03/067797 (Philips). The security display device comprises an array of LCD (Liquid Crystal Display) elements for displaying one part or “share” of an encrypted image, the other “share” being displayed on a terminal. The device is preferably transparent so that the user can see both “shares” simultaneously and thereby visually reconstruct the image. Such a device may advantageously be provided with sensors to assist the positioning of the device on the terminal. In an alternative embodiment, as described in International Patent Application PCT/IB03/04449 (attorney docket PHNL021058), the rear face of the security display device is provided with an array of sensors for sensing the image displayed on the terminal.

The security display devices mentioned above may have both an array of display elements and an array of sensor elements. Although this may offer several advantages over devices having only a single array of display elements, it will be clear that the additional array of sensors adds to the complexity of the device and increases its cost. It is consequently desirable to preserve the advantages of the additional array of sensors while keeping the device as simple as possible.

It is therefore an object of the present invention to overcome these and other problems of the Prior Art and to provide a security device having both display elements and sensor elements, which device has a reduced number of parts.

Accordingly, the present invention provides a device for decrypting encrypted images, the device comprising:
an array of sensor elements for sensing a first image, and
an array of display elements for displaying a second image,
wherein at least some display elements are combined elements which comprise integrated sensor elements.

By using display elements having integrated sensor elements, the number of parts is significantly reduced. In fact, it is possible for the device of the present invention to have substantially the same number of parts as a security display device having no sensors.

The first image may be an encrypted image or a first “share” of an image consisting of two such “shares”, while the second image may be a decrypted image or a second “share”. The encrypted image may be encrypted by permutation, by cryptographic processing involving a key, or by other techniques.

The term “combined elements having integrated sensor elements”, as used in this document, encompasses both display elements which are combined with separately produced sensor elements to form integrated elements, and display elements which are also capable of functioning as sensor elements. Combined elements may be used to reduce the number of parts of the security display device and/or to reduce production costs. However, display elements which may also serve as sensor elements are preferred as they reduce the complexity of the device even further. In such embodiments, the display elements and the sensor elements may be structurally the same and the term “integrated elements” may be used to refer to array elements having both functions.

In a preferred embodiment, the combined display elements are constituted by polymeric (organic) LED (Light Emitting Diode) elements. Polymeric (organic) LED elements, often called PLEDs, are capable of producing light when a positive bias voltage is applied, while they may detect incident light when a negative bias voltage is applied. PLEDs are described in more detail in, for example, U.S. Pat. No. 5,504,323, the entire contents of which are hereby incorporated in this document.

In an alternative embodiment, the combined display elements are constituted by small molecule organic LED (Light Emitting Diode) elements, often called small molecule OLEDs or simply OLEDs. It is noted that PLEDs and OLEDs are not mutually exclusive and that PLEDs may contain organic materials, such as organic polymers.

In some embodiments, the display elements and the sensor elements face in the same direction. That is, the light produced by the integrated elements passes through the same surface as the light detected by the elements. The same side of the device may be used for sensing and displaying. If necessary, the device may be turned over, depending on whether the device is used for sensing or displaying. In other embodiments, the display elements and the sensor elements face in opposite directions. This has the advantage that the device is capable of sensing on one side and displaying on the opposite side, thus allowing these two functions to be carried out simultaneously.

Various uses of the device of the present invention can be envisaged. In the case of “visual cryptography” as disclosed in WO 03/067797 mentioned above where an image is encrypted by producing two partial images or “shares”, it is preferred that the array of display elements is substantially transparent. This allows one “share” to be visible through the security display device when the device is placed in front of a terminal showing this “share”. If the device displays the other “share”, the user will be able to see both “shares” and will thus be able to view the decrypted image.

However, in other applications it is not necessary or even desirable for the device to be substantially transparent. In one such application images are encrypted by permuting their pixels (picture elements) and the decryption process involves (inversely) permuting the encrypted image. In an advantageous embodiment, therefore, the array of display elements is substantially opaque, the device preferably being arranged for permuting the first image so as to produce the second image.

Instead of, or in addition to an encrypted image, the sensor elements may be used for sensing other images and/or visual information. In one embodiment, for example, the first image comprises positioning information for positioning the device. This positioning information may comprise marks or signs which may be arranged on the terminal for correctly positioning the device relative to the terminal. Although it is preferred that the sensor elements of the array are used for positioning the device, it is also possible to provide additional sensor elements or cameras for this purpose.

The array of sensor elements may also be advantageously utilized for identifying the user of the device. Accordingly, in an advantageous embodiment the first image, which is sensed by the sensor elements, comprises user identification information. This information may comprise biometric information such as a fingerprint or a handwritten word and may, for example, be read by placing the sensor array in front of a finger or a piece of paper containing handwriting.

In another advantageous embodiment, the device is further arranged for receiving user input via the sensor elements and transmitting the user input to a terminal. The user input may comprise commands, which may be entered using a light pen, stylus or finger, and are transmitted to a terminal using a wireless or infra-red transmission path, for example utilizing the Bluetooth™ protocol. In this way, a return path may be established from a (trusted) user device to an (un-trusted) terminal device, such as an ATM (Automatic Teller Machine) or a (public) internet terminal.

The present invention further provides a system for visual cryptography, comprising a device as defined above, as well as an array of display elements having integrated sensor elements for use in the device as defined above.

The present invention will further be explained below with reference to exemplary embodiments illustrated in the accompanying drawings, in which:

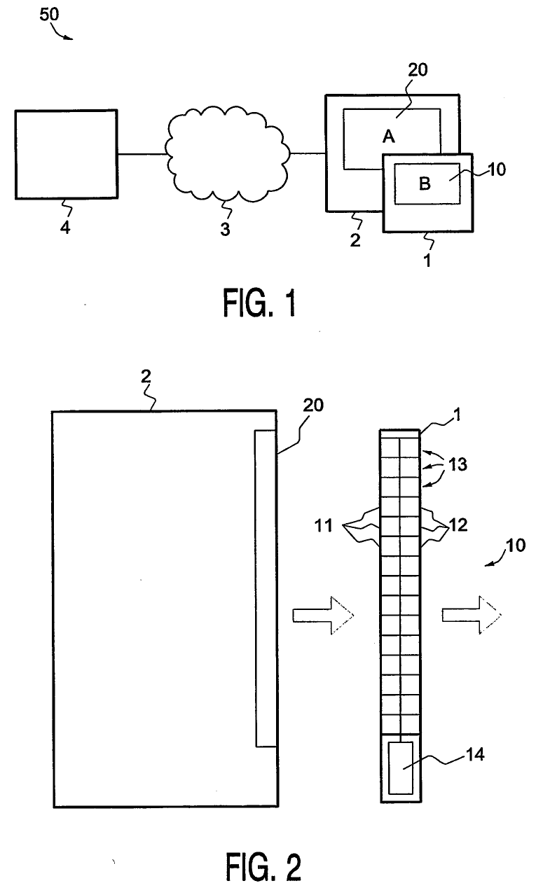

FIG. 1 schematically shows a system for visual cryptography in accordance with the present invention.

FIG. 2 schematically shows, in a cross-sectional view, the device of the present invention together with a terminal.

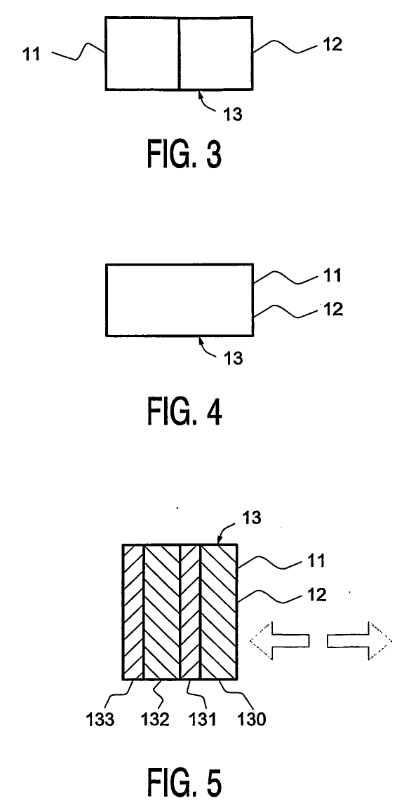

FIG. 3 schematically shows, in a cross-sectional view, a first embodiment of an array element as used in the present invention.

FIG. 4 schematically shows, in a cross-sectional view, a second embodiment of an array element as used in the present invention.

FIG. 5 schematically shows, in a cross-sectional view, the array element of FIG. 4 in more detail.

The system 50 shown merely by way of non-limiting example in FIG. 1 comprises a security display device (decryption device) 1, a terminal 2, a communications network 3 and a server 4. The server 4 produces and encrypts images which are transmitted via the communication network 3 to the terminal 2. The communication network 3 may be constituted by a dedicated network such as a LAN, a telephone network (POTS), the Internet, or a simple cable or wire. Both the server 4 and the terminal 2 may be dedicated devices or may be constituted by general purpose computers with, at least in the case of terminal 2, a display screen 20. The decryption device 1, which is provided with a display screen 10, will be discussed in more detail below. The server 4 and the decryption device 1 may both be provided with at least one key set consisting of a plurality of cryptographic keys. These keys are used in a suitable cryptographic process, such as DES (“Data Encryption Standard”, a well-known data encryption method). The particular cryptographic process used is not essential.

The system 50 may be used for secure transactions, for example financial transactions. The terminal 2 may, for example, be constituted by a personal computer, the server 4 being the server of a financial institution or a vendor. Alternatively, the terminal 2 can be an ATM (Automatic Teller Machine). The security display device 1 preferably is a so-called trusted device carried by its user and serves to obtain secure information using a non-trusted device, that is, the terminal 2. An (entirely or partially encrypted) image A displayed on the display screen 20 of the terminal 2 may be decrypted by the decryption device 1, resulting in a decrypted image B displayed on the display screen 10 of the decryption device 1.

As shown in the exemplary embodiment of FIG. 2, the screen 10 of the decryption device 1 comprises sensor elements 11 for sensing a first image, for example an encrypted image displayed on the screen 20 of the terminal 2. In the embodiment shown, the opposite face of the decryption device 1 is provided with display elements 12, for example for displaying a decrypted image. Both the sensor elements 11 and the display elements 12 are arranged in a two-dimensional array.

The device 1 of FIG. 2 further comprises a processor 14 with an associated memory for performing cryptographic operations on the sensed image. Electrical conductors or optical fibers (not shown) connect the sensor elements 11 and the display elements 12 to the processor 14. A set of cryptographic keys may be stored in the processor memory. The decryption device 1 is therefore capable of sensing an encrypted image, decrypting the image, and displaying the resulting decrypted image. While the terminal 2 is a non-trusted device, the decryption device 1 is a trusted device which is preferably carried by its user and stored in a safe place when not in use. In this way the keys stored in the decryption device, which is also called security display device, are not compromised.

It is noted that the device 1 may comprise additional sensor elements (not shown) for sensing positioning information which serves to position the device 1 relative to the terminal 2. Such additional sensor elements may be arranged in one-dimensional arrays. It is further noted that a return path may exist from the user device 1 to the terminal 2 to provide feedback to the server 4. The return path may, for example, involve wireless or infrared communications, and may serve to transmit a user identification or other information to the server. Such a return path may, for example, utilize the Bluetooth™ protocol.

In accordance with the present invention, a sensor element 11 is integrated in a display element 12 to form a single, combined array element 13. Accordingly, the display screen 10 of the decryption (security display) device 1 is constituted of combined elements 13. It is noted that embodiments can be envisaged in which not all array elements are combined array elements 13. The number of sensor elements 11 can be both smaller and larger than the number of display elements 12. Although array elements 13 may be used which are formed by display elements in which sensor elements are embedded, it is preferred that the array elements are constituted by display elements which are also capable of functioning as sensor elements and which are therefore bi-functional. Suitable array elements may be PLED elements which are capable of both producing and detecting light.

In FIG. 3 an array element 13 is schematically shown to consist of a sensor part (sensor element) 11 and a display part (display element) 12, arranged at opposite sides of the combined element 13. It will be understood that the elements 11 and 12 need not be physically distinct and may be constituted by opposite sides of the same component.

In the alternative embodiment of FIG. 4, the sensor part 11 and the display part 12 are arranged at the same side of the combined element 13. Which of these embodiments is utilized depends on the particular technology used to implement the combined elements 13 and on the application for which the device is designed. If the security display device is of the permuting type discussed above, it is feasible to use the one-sided embodiment of FIG. 4, first turning the device towards the terminal to sense the encrypted image and then turning the device around to show the decrypted image to the user. In the case of visual cryptography involving two “shares” which must be viewed simultaneously, the embodiment of FIG. 3 is preferred.

The exemplary embodiment of FIG. 4 is shown in more detail in the schematic cross-sectional view of FIG. 5. The combined PLED element 13 of FIG. 5 is shown to comprise a substrate 130, a first layer 131, a second layer 132 and a third layer 133. The (optional) substrate 130, which supports the layers of the element 13, is transparent to allow both incident and emitted light to pass through, as indicated by the arrows in FIG. 4. Hole-injecting (first) layer 131 serves as a positive electrode while electron injecting (third) layer 133 serves as the negative electrode.

The intermediate active (second) layer 132 is preferably made up of a semiconducting luminescent conjugated organic polymer. The electron injecting layer 133 is a conductive layer which may be made of metal. The first or hole-injecting layer 131 is substantially transparent. The active or second layer 132 in the diode structure 13 is semi-conductive and preferably incorporates one or more conjugated polymers. Elements of this type are discussed in more detail in U.S. Pat. No. 5,504,323 mentioned above.

Other embodiments of the combined elements 13 comprise OLEDs, in particular so-called small molecule OLEDs. Although the element 13 of FIG. 5 receives and emits light at the same side of the (unidirectional) element, it is possible to produce bi-directional elements by making the third (electrode) layer 133 substantially transparent. Other structures are, of course, also possible, for example structures having a glass or plastic substrate on either side, the electrodes being constituted by layers of transparent conducting oxide deposited on the substrates.

The present invention is based upon the insight that the number of parts of security display devices can be significantly reduced by using array elements which combine a display element and a sensor element into a single integrated element. The present invention benefits from the further insight that polymeric LEDs are particularly suitable for this purpose.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (1) for decrypting encrypted images, the device comprising:
an array of sensor elements (11) for sensing a first image (A), and
an array of display elements (12) for displaying a second image (B),
wherein at least some display elements are combined elements (13) which comprise integrated sensor elements.

2. The device according to claim 1, wherein the combined elements (13) are constituted by polymer organic LED elements.

3. The device according to claim 1, wherein the combined elements (13) are constituted by small molecule organic LED elements.

4. The device according to claim 1, wherein the sensor elements (11) and the display elements (12) face in the same direction.

5. The device according to claim 1, wherein the sensor elements (11) and the display elements (12) face in opposite directions.

6. The device according to claim 1, wherein the array of display elements (12) is substantially transparent.

7. The device according to claim 1, wherein the array of display elements (12) is substantially opaque, the device preferably being arranged for permuting the first image (A) so as to produce the second image (B).

8. The device according to claim 1, wherein the first image (A) comprises positioning information for positioning the device.

9. The device according to claim 1, wherein the first image (A) comprises user identification information.

10. The device according to claim 1, further arranged for receiving user input via the sensor elements (11) and transmitting the user input to a terminal (2).

11. A system for visual cryptography, comprising a device (1) according to claim 1.

12. An array of combined display elements (13) having integrated sensor elements (11) for use in the device according to claim 1.
